(19) United States
(12) Patent Application Publication
(10) Pub. No.: US 2020/0035441 A1
(43) Pub. Date: Jan. 30, 2020

(54) OBJECTIVE LENS AND CONDENSER LENS FOR AN X-RAY TUBE, X-RAY TUBE AND A METHOD FOR OPERATING SUCH AN X-RAY TUBE

(71) Applicant: YXLON International GmbH, Hamburg (DE)

(72) Inventors: André Schu, Schwarzenbek (DE); Bjoern Schrader, Hamburg (DE); Nicole Frindt, Hamburg (DE)

(21) Appl. No.: 16/043,349

(22) Filed: Jul. 24, 2018

(51) Int. Cl. H01J 35/14; G02B 19/00; G02B 13/00

(52) U.S. Cl. CPC H01J 35/14; G02B 13/0015; G02B 19/0033

(57) ABSTRACT

An objective lens and condenser lens for an X-ray tube with an objective lens inner core, an inner objective lens coil arranged thereon and an objective lens outer core arranged around it. An outer objective lens coil is arranged between inner objective lens coil and objective lens outer core, wherein the outer objective lens coil has two objective lens wire sections with the same number of turns. The condenser lens includes a condenser lens inner core, an inner condenser lens coil arranged on the condenser lens inner core and a condenser lens outer core arranged around the inner condenser lens coil, wherein an outer condenser lens coil is arranged between the inner condenser lens coil and the condenser lens outer core, wherein the outer condenser lens coil has two condenser lens wire sections with the same number of turns.

### CROSS REFERENCE TO RELATED APPLICATIONS

This application is related to and claims priority under 35 U.S.C. § 119(a) to German patent application No. 102017007479.8, filed Aug. 8, 2017, the contents of which are incorporated by reference herein in its entirety.

### BACKGROUND OF THE INVENTION

### 1. Field of Invention

The invention relates to an objective lens for an X-ray tube, a condenser lens for an X-ray tube, as well as an X-ray tube with such an objective lens and/or such a condenser lens and a method for operating such an X-ray tube. The X-ray tube is in particular a microfocus X-ray tube.

### 2. Description of the Related Art

During operation of X-ray tubes, and this applies to a much greater extent to microfocus X-ray tubes, the shape, size and position of the focal spot changes. This results in part from temperature changes in the components of the X-ray tube. Such changes in the focal spot have a negative effect on the imaging quality when the X-ray tube is used in imaging methods.

A solution to this problem is presented in DE 10 2010 032 338 A1 to the effect that the coils of the X-ray tube are thermally stabilized via unregulated cooling by means of a cooling fluid. The X-ray tube is cooled independently of external influences with a constant volume flow rate of the cooling medium. An undefined temperature equilibrium arises depending on the tube power, ambient temperature and coil currents. Compared with an uncooled X-ray tube, a temperature equilibrium with a lower absolute value is thereby achieved. This results in a smaller temperature difference from the ambient temperature, whereby a temperature equilibrium can be achieved more quickly. This approach is complex because channels for the cooling fluid have to be introduced into the coils and the cooling circuit has to be arranged in a high-vacuum environment or the cooling has to be applied to the outside of the X-ray tube, making the X-ray tube much larger.

### SUMMARY OF THE INVENTION

An object of the invention is therefore to provide alternative means by which the focal spot can be kept as constant as possible, but which do not involve any complex cooling with cooling fluids.

The object is achieved by an objective lens according to the features of claim 1. As the two objective lens wire sections of the outer objective lens coil have the same number of turns, it is possible to supply these with current with the same current strength, with the result that their respective magnetic field is equally large in terms of value. If it is ensured that these magnetic fields are oppositely aligned, they cancel each other out and a resulting total magnetic field of zero is obtained. This can be effected essentially by two designs: either the turns are realized in opposite directions, then the two objective lens wire sections can be connected in series and can be supplied with current by the same filament current source, or the two objective lens wire sections are not realized in opposite directions, then they have to be supplied with current with the same current strength but in opposite directions. A person skilled in the art knows how to produce such embodiments. The total magnetic field of the outer objective lens coil thus does not influence the guidance of the electron beam of the X-ray tube, but rather serves only to generate heat in the objective lens coil. As a result—similarly to the state of the art—the temperature difference over time is decreased here. The effect of stabilizing the focal spot of the X-ray tube is thus obtained without the use of the cooling fluid, which is complex to introduce into the objective lens coil.

The object is also achieved by a condenser lens with the features of claim 2. The design of the condenser lens according to the invention is in principle the same as that of the objective lens according to the invention just described, with the advantages specified there.

An advantageous development of the invention provides that the two objective lens wire sections of the outer objective lens coil of the objective lens or the two condenser lens wire sections of the outer condenser lens coil of the condenser lens are wound in opposite directions. This results in the advantage over a parallel winding already outlined above that the supply of current to the two objective lens wire sections or respectively to the two condenser lens wire sections can be effected with the same filament current source without additional devices, by means of a series connection.

The object is also achieved by a condenser lens with the features of claim 4. Because the inner condenser lens coil is divided into an even number of magnetic field wire sections—for example 2, 4, 6, 8 or 10, the field strength of the magnetic field generated by this inner condenser lens coil can be varied, with unchanged power input to the inner condenser lens coil, in that the individual magnetic field wire sections are supplied with current such that the (partial) magnetic fields of the individual magnetic field wire sections being generated in each case—which are equally large in terms of value at the same current strength as there is the same number of windings in each case—cancel each other out or are strengthened, and thus the resulting total field strength is zero at one extreme and is the sum of all individual field strengths at the other extreme. The power input to the entire inner condenser lens coil is not changed, even though different field strengths can be generated; the power input is therefore kept constant. The result is thus that there is no change in the focal spot due to thermal changes in the inner condenser lens coil for magnetic fields of different strength, which are generated in the condenser lens coil. It goes without saying that the more magnetic field wire sections there are, the finer the subdivision between the achievable magnetic field strengths becomes. Thus, when two magnetic field wire sections are used, it is only possible to cut off the inner condenser lens coil (total field strength is zero) or to generate the full field strength. When six magnetic field wire sections are used, in contrast, two intermediate stages can be selected (one third or two thirds of the total field strength).

An advantageous development of the invention provides that the number of magnetic field wire sections is four. Through the division into four magnetic field wire sections, in addition to the switched-off mode (field strength zero with opposite field strengths of in each case two of the magnetic field wire sections) and the full field strength (all four individual field strengths are added together) a mode with half the field strength can also be set (three field strengths are oriented in one direction and one field strength is oriented in the opposite direction, with the result that two field strengths cancel each other out overall).

The object is also achieved by an X-ray tube with the features of claim 6. Because the filament current source supplies the objective lens wire sections or respectively the condenser lens wire sections with current with the same current strength, but field strengths in opposite directions are generated, the magnetic fields cancel each other out and no magnetic field is obtained despite the generation of heat in the respective coil. The advantages already stated above in relation to claim 1 thus result. A person skilled in the art knows how he has to connect the filament current source to the objective lens wire sections or respectively to the condenser lens wire sections in order to achieve the specified individual field strengths.

An advantageous development of the invention provides that the two objective lens wire sections of the outer objective lens coil and/or the two condenser lens wire sections of the outer condenser lens coil are connected in series. When the respective wire sections are wound in opposite directions and connected in series, only a single filament current source can be used for the outer objective lens coil or respectively the outer condenser lens coil, which can carry out the current supply in a very simple manner without additional elements.

A further advantageous development of the invention provides that at least one of the filament current sources is connected to a control system, which is connected to a temperature sensor which measures the temperature of the objective lens and/or of the condenser lens. With such a control system, the heat output can be altered, with the result that the temperature of the objective lens and/or of the condenser lens can be adapted to changed circumstances, whereby an even better stabilization of the focal spot can be achieved.

The object is also achieved by an X-ray tube with the features of claim 9. For such an X-ray tube, the advantages which have been stated above with respect to claim 4 and its development with four magnetic field wire sections result.

The object is also achieved by a method for operating an X-ray tube with the features of claim 10. With the two operating modes according to the invention (total field strength zero and maximum field strength), the same advantages are reaches which have already been stated above with respect to claim 4.

An advantageous development of the invention provides that the magnetic fields of the individual magnetic field wire sections of the inner condenser lens coil partially cancel each other out in a third operating mode. Depending on the number of magnetic field wire sections present, a particular number of intermediate stages (between field strength zero and full field strength) can thereby be selected, whereby the use of the X-ray tube becomes more flexible without the generation of heat that occurs due to the power introduced being altered.

### BRIEF DESCRIPTION OF THE DRAWINGS

Further advantages and details of the invention are explained in more detail in the following with reference to the embodiment example represented in the figures. There are shown in:

FIG. 1 is a schematic longitudinal section through a condenser lens according to the invention and an objective lens according to the invention of an X-ray tube according to the invention,

FIG. 2a is a schematic representation of a first operating mode according to the invention of an X-ray tube according to the invention,

FIG. 2b is a schematic representation of a third operating mode according to the invention of an X-ray tube according to the invention, and

FIG. 2c is a schematic representation of a second operating mode according to the invention of an X-ray tube according to the invention.

### DETAILED DESCRIPTION THE INVENTION

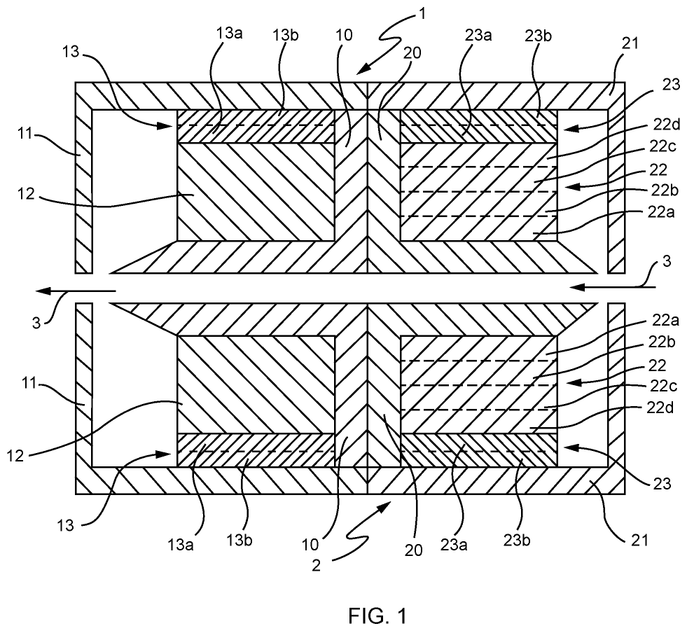

A detail of a microfocus X-ray tube according to the invention in the region of its condenser lens 2 and its objective lens 1 is represented in a schematic longitudinal section in FIG. 1. The rest of the microfocus X-ray tube, not represented, corresponds to the state of the art and is not relevant to the invention. Instead of a microfocus X-ray tube, it can also be another type of X-ray tube.

Condenser lens 2 and objective lens 1 are arranged around a tube for the electron beam 3. The condenser lens 2 lies in front of the objective lens 1 in the direction of the electron beam 3.

The condenser lens 2 has a condenser lens inner core 20, which is realized rotationally symmetrical about the tube for the electron beam 3, which is formed by it. The condenser lens inner core 20 also extends perpendicular to the electron beam 3 and on its outside forms a part of an outer wall, in that it has the shape of a tube there.

In front in the direction of the electron beam 3 a condenser lens outer core 21 is arranged which, in addition to a front wall extending perpendicular to the electron beam 3—which has an opening for the electron beam 3 in the centre—has a tubular component, which is also part of the outer wall and is flush with the part of the outer wall which is formed by the condenser lens inner core 20.

An inner condenser lens coil 22 is arranged on the central part of the condenser lens inner core 20, which also forms the tube for the electron beam 3. This has four wire sections, each with an identical number of turns, which in the direction of the electron beam 3 are arranged one above another (this version is shown in FIG. 1) or one after another as follows: first magnetic field wire section 22a, second magnetic field wire section 22b, third magnetic field wire section 22c, fourth magnetic field wire section 22d.

An outer condenser lens coil 23 is arranged around the inner condenser lens coil 22. This has two wire sections, each with an identical number of turns, which in the direction of the electron beam 3 are arranged one above another (this version is shown in FIG. 1) or one after another as follows: first condenser lens wire section 23a, second condenser lens wire section 23b. These two wire sections are wound in the opposite direction to one another.

The objective lens 1 has an objective lens inner core 10, which is realized rotationally symmetrical about the tube for the electron beam 3, which is formed by it. It also extends perpendicular to the electron beam 3 and on its outside forms a part of the outer wall, in that it has the shape of a tube there. This part of the outer wall is flush with the part of the outer wall which is formed by the objective lens inner core 10, and joined to it.

In front in the direction of the electron beam 3 an objective lens outer core 11 is arranged which, in addition to a front wall extending perpendicular to the electron beam 3—which has an opening for the electron beam 3 in the centre—has a tubular component, which is also part of the outer wall and is flush with the part of the outer wall which is formed by the objective lens inner core 10.

An inner objective lens coil 12 is arranged on the inner part of the objective lens inner core 10, which also forms the tube for the electron beam 3, as is known from the state of the art.

An outer objective lens coil 13 is arranged around the inner objective lens coil 12. This has two wire sections, each with an identical number of turns, which in the direction of the electron beam 3 are arranged one above another (this version is shown in FIG. 1) or one after another as follows: first objective lens wire section 13a, second objective lens wire section 13b. These two wire sections are wound in the opposite direction to one another.

Both the first condenser lens wire section 23a and the second condenser lens wire section 23b, wound in opposite directions and having the same number of turns, are supplied with the same current by a second filament current source (not represented); for this they can be connected in series directly one behind the other. A resulting field strength of zero thus results for the entire outer condenser lens coil 23 as the two magnetic fields which are generated by the two wire sections cancel each other out. When supplied with current, the outer condenser lens coil 23 thus produces only heat, but no magnetic field which would affect the path of the electron beam 3. Changing the existing current strength of the second filament current source can thus influence the heat of the entire condenser lens 2. By means of a temperature sensor (not represented), which detects the temperature of the condenser lens 2, and a control system connected thereto (not represented), the temperature of the condenser lens 2 can be kept substantially constant via the change in the current strength of the second filament current source, resulting in no change in the focal spot of the microfocus X-ray tube due to thermal influences with respect to the condenser lens 2. Such a device with temperature sensor, control system and second filament current source is known, in principle, to a person skilled in the art.

The same applies to the outer objective lens coil 13 as just stated for the outer condenser lens coil 23: both the first objective lens wire section 13a and the second objective lens wire section 13b, wound in opposite directions and having the same number of turns, are supplied with the same current by a first filament current source (not represented); for this they can be connected in series one directly behind the other. A resulting field strength of zero thus results for the entire outer objective lens coil 13 as the two magnetic fields which are generated by the two wire sections cancel each other out. When supplied with current, the outer objective lens coil 13 thus produces only heat, but no magnetic field which would affect the path of the electron beam 3. Changing the existing current strength of the first filament current source can thus influence the heat of the entire objective lens 1. By means of a temperature sensor (not represented), which detects the temperature of the objective lens 1, and a control system connected thereto (not represented), the temperature of the objective lens 1 can then be kept substantially constant via the change in the current strength of the first filament current source, resulting in no change in the focal spot of the microfocus X-ray tube due to thermal influences with respect to the objective lens 1. Such a device with temperature sensor, control system and first filament current source is known, in principle, to a person skilled in the art.

Not the outer condenser lens coil 23 and the outer objective lens coil 13, but rather the inner condenser lens coil 22 and the inner objective lens coil 12 are thus responsible for the change in the electron beam 3. With regard to the inner objective lens coil 12, this is an objective lens coil known from the state of the art, which in terms of its structure is not essential to the invention and therefore the mode of operation of which need not be described in more detail.

However, the inner condenser lens coil 22 according to the invention is basically constructed differently—see above explanations—from a condenser lens coil known from the state of the art. In the case of the known condenser lens coil described in the following, it is assumed that it has as many turns as the sum of the four wire sections of the inner condenser lens coil 22 according to the invention. The other specific features should also correspond in order to make it possible to compare a condenser lens coil according to the state of the art and an inner condenser lens coil 22 according to the invention.

In the case of a known condenser lens coil which has only one continuous winding, the strength of the magnetic field is adjusted by a change in the current of a current source connected to the condenser lens coil. Should no magnetic field be present, the current strength is 0 A. The power input to the condenser lens coil is thus 0 W. The temperature of the condenser lens coil is then, for example, 25° C. If a medium magnetic field is required, a current strength of 1 A, for example, is used, which leads to a power input of 15 W in the case of a regularly applied voltage of 15 V, whereby the condenser lens coil has a temperature of 35° C., for example. In the case of a strong magnetic field a current strength of 2 A, for example, is used, in the case of a voltage of 30 V a power input of 60 W and a temperature of the condenser lens coil of, for example, 60° C. are obtained. The significant temperature change has an influence on the focal spot.

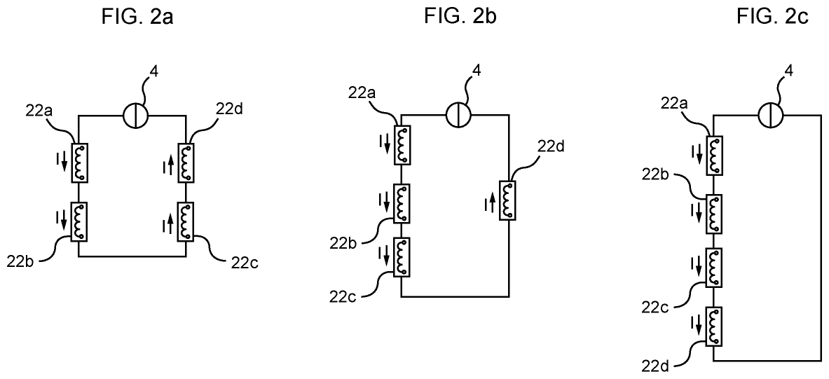

The structure of the inner condenser lens coil 22 according to the invention with four wire sections with the same number of turns makes it possible to keep the power input constant by different interconnections of the four wire sections to one another, which are explained in more detail in the following and are represented in FIGS. 2a-2d, which leads to a constant temperature of the inner condenser lens coil 22—in the case of the other boundary conditions which were stated in the preceding paragraph in relation to the condenser lens coil known from the state of the art. The four wire sections are connected to a magnetic field current source 4, which is constantly operated with a current of 2 A, as is the case with the strong magnetic field in the case of the known condenser lens coil described in the preceding paragraph. In the case of an identical voltage to that described above, a power input of 60 W is thus always present. This means that the temperature of the inner condenser lens coil is constantly at, for example, 60° C. In order to make the different magnetic field strengths of the entire inner condenser lens coil 22 described in the following possible, the magnetic field current source 4 is connected to the four wire sections—first magnetic field wire section 22a, second magnetic field wire section 22b, third magnetic field wire section 22c, fourth magnetic field wire section 22d via a circuit known to a person skilled in the art, which makes different current directions in the individual wire sections possible.

A circuit is shown in FIG. 2a in which the current flows through the first magnetic field wire section 22a and the second magnetic field wire section 22b in the same direction, but the current flows through the third magnetic field wire section 22c and the fourth magnetic field wire section 22d in the opposite direction to that through the two first-mentioned sections. It therefore results that the magnetic fields of the individual wire sections cancel each other out and no resulting magnetic field is present.

A circuit is shown in FIG. 2b in which the current flows through the first magnetic field wire section 22a, the second magnetic field wire section 22b and the third magnetic field wire section 22c in the same direction, but the current flows through the fourth magnetic field wire section 22d in the opposite direction to that through the three first-mentioned sections. It therefore results that two partial magnetic fields cancel each other out and the resulting magnetic field is the sum of two of the wire sections. This corresponds to the weak magnetic field in the case of the known condenser lens coil, as has been described above.

A circuit is shown in FIG. 2c in which the first magnetic field wire section 22a, second magnetic field wire section 22b, third magnetic field wire section 22c and fourth magnetic field wire section 22d all have the current flow through them in the same direction. A magnetic field therefore results which is four times as large as that of an individual wire section. This corresponds to the strong magnetic field in the case of the known condenser lens coil, as has been described above.

It is clear that in the case of a greater subdivision of the turns of the inner condenser lens coil 22 into even more wire sections an even finer adjustment of intermediate magnetic field strengths can be produced, between zero and the full magnetic field strength, when the current flows through all wire sections in the same direction.

In summary, one of the main aspects according to the invention is that different magnetic field strengths on the inner condenser lens coil 22 at a constant temperature thereof can be achieved only by distributing the direction of the current flow differently in the wire sections by means of a circuit. Since no temperature change occurs despite a change in magnetic field strength, a change in the focal spot due to thermal influences is eliminated.

It is not absolutely necessary for all of the individual wire sections of the inner condenser lens coil 22 to have the same number of turns. In principle, any other subdivision is possible; it should merely be ensured that at least one combination is possible in which a total magnetic field strength of zero results. Thus, for example, a subdivision of the total number of turns in the ratio of 1/4+1/8+1/8+1/8+1/8+1/4 would also be possible.

### LIST OF REFERENCE NUMBERS

1 objective lens
2 condenser lens
3 electron beam
4 magnetic field current source
10 objective lens inner core
11 objective lens outer core
12 inner objective lens coil
13 outer objective lens coil
13a first objective lens wire section
13b second objective lens wire section
20 condenser lens inner core
21 condenser lens outer core
22 inner condenser lens coil
22a first magnetic field wire section
22b second magnetic field wire section
22c third magnetic field wire section
22d fourth magnetic field wire section
23 outer condenser lens coil
23a first condenser lens wire section
23b second condenser lens wire section

1. An objective lens (1) for an X-ray tube, in particular a microfocus X-ray tube, comprising an objective lens inner core (10), an inner objective lens coil (12) arranged on the objective lens inner core (10) and an objective lens outer core (11) arranged around the inner objective lens core (10),
wherein an outer objective lens coil (13) is arranged between the inner objective lens coil (12) and the objective lens outer core (11),
wherein the outer objective lens coil (13) has two objective lens wire sections (13a, 13b) with the same number of turns.

2. A condenser lens (2) for an X-ray tube, in particular a microfocus X-ray tube, comprising a condenser lens inner core (20), an inner condenser lens coil (22) arranged on the condenser lens inner core (20) and a condenser lens outer core (21) arranged around the inner condenser lens coil (22),
wherein an outer condenser lens coil (23) is arranged between the inner condenser lens coil (22) and the condenser lens outer core (21),
wherein the outer condenser lens coil (23) has two condenser lens wire sections (23a, 23b) with the same number of turns.

3. The objective lens (1) of claim 1, wherein the two objective lens wire sections (13a, 13b) of the outer objective lens coil (13) of the objective lens (1) are wound in opposite directions.

4. A condenser lens (2) for an X-ray tube, in particular a microfocus X-ray tube, comprising: a condenser lens inner core (20), an inner condenser lens coil (22) arranged on the condenser lens inner core (20) and a condenser lens outer core (21) arranged around the inner condenser lens coil (22), wherein the inner condenser lens coil (22) has an even number of magnetic field wire sections (22a, 22b, 22c, 22d), each with the same number of turns.

5. The condenser lens (2) according to claim 4, wherein the number of magnetic field wire sections (22a, 22b, 22c, 22d) is four.

6. A microfocus X-ray tube having the objective lens of claim 1 and further comprising: a condenser lens inner core (20), an inner condenser lens coil (22) arranged on the condenser lens inner core (20) and a condenser lens outer core (21) arranged around the inner condenser lens coil (22), wherein an outer condenser lens coil (23) is arranged between the inner condenser lens coil (22) and the condenser lens outer core (21), wherein the outer condenser lens coil (23) has two condenser lens wire sections (23a, 23b) with the same number of turns; wherein the outer objective lens coil (13) is connected to a first filament current source and/or the outer condenser lens coil (23) is connected to a second filament current source, wherein the filament current sources are installed such that the two objective lens wire sections (13a, 13b) of the outer objective lens coil (13) generate magnetic fields that cancel each other out and/or the two condenser lens wire sections (23a, 23b) of the outer condenser lens coil (23) generate magnetic fields that cancel each other out.

7. The X-ray tube according to claim 6, wherein the two objective lens wire sections (13a, 13b) of the outer objective lens coil (13) of the objective lens (1) or the two condenser lens wire sections (23a, 23b) of the outer condenser lens coil (23) of the condenser lens (2) are wound in opposite directions; and wherein the two objective lens wire sections (13a, 13b) of the outer objective lens coil (13) and/or the two condenser lens wire sections (23a, 23b) of the outer condenser lens coil (23) are connected in series.

8. The X-ray tube according to one of claim 6, wherein at least one of the filament current sources is connected to a control system, which is connected to a temperature sensor which measures the temperature of the objective lens (1) and/or of the condenser lens (2).

9. The X-ray tube, in particular microfocus X-ray tube, of claim 2, wherein there is a magnetic field current source (4), which is connected to the inner condenser lens coil (22).

10. A method for operating the microfocus X-ray tube of claims 6 to 9, wherein the magnetic fields of the individual magnetic field wire sections (22a, 22b, 22c, 22d) of the inner condenser lens coil (22) cancel each other out in a first operating mode and are all added together in a second operating mode.

11. The method according to claim 10, wherein the magnetic fields of the individual magnetic field wire sections (22a, 22b, 22c, 22d) of the inner condenser lens coil (22) partially cancel each other out in a third operating mode.

12. The condenser lens (2) according to claim 2, wherein the two condenser lens wire sections (23a, 23b) of the outer condenser lens coil (23) of the condenser lens (2) are wound in opposite directions.

13. A microfocus X-ray tube having the objective lens of claim 1 and further comprising: a condenser lens inner core (20), an inner condenser lens coil (22) arranged on the condenser lens inner core (20) and a condenser lens outer core (21) arranged around the inner condenser lens coil (22), wherein the inner condenser lens coil (22) has an even number of magnetic field wire sections (22a, 22b, 22c, 22d), each with the same number of turns; wherein the outer objective lens coil (13) is connected to a first filament current source and/or the outer condenser lens coil (23) is connected to a second filament current source, wherein the filament current sources are installed such that the two objective lens wire sections (13a, 13b) of the outer objective lens coil (13) generate magnetic fields that cancel each other out and/or the two condenser lens wire sections (23a, 23b) of the outer condenser lens coil (23) generate magnetic fields that cancel each other out.
